(19) United States
(12) Patent Application Publication
(10) Pub. No.: US 2012/0249737 A1
(43) Pub. Date: Oct. 4, 2012

(54) DEVICE FOR OBTAINING STEREOSCOPIC IMAGES FROM A CONVENTIONAL ENDOSCOPE WITH SINGLE LENS CAMERA

(76) Inventors: SANDEEP SOOD, TROY, MI (US); BEENA GAIND SOOD, TROY, MI (US)

(21) Appl. No.: 13/423,254

(22) Filed: Mar. 18, 2012

Related U.S. Application Data
(60) Provisional application No. 61/516,303, filed on Apr. 2, 2011.

(51) Int. Cl. H04N 13/00

(52) U.S. Cl. 348/45; 348/E13.001

(57) ABSTRACT

The present invention discloses a device for obtaining stereoscopic images with conventional single optic channel endoscope using a single lens camera. The device comprises of an aperture each half of which is covered with complimentary additive and subtractive color filters and is installed between the endoscope and camera. The filters can be transversely adjusted to center on the principal ray so as to obtain optimal stereopsis. Images are viewed on a standard monitor using eyewear comprising the same complimentary additive and subtractive color filters on the left and the right side, or on specialized video monitors using active or passive polarized glasses.

### CROSS REFERENCE TO RELATED APPLICATIONS

The application claims the benefit of priority of U.S. Provisional Application No. 61/516,303, filed Apr. 2, 2011, entitled “A Device For Obtaining Stereoscopic Images From a Conventional Endoscope with Single Lens Camera”, the disclosure of which is expressly incorporated herein by reference in its entirety.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF INVENTION

This invention relates generally to the field of stereoscopic imaging using conventional single optic channel endoscopes with single lens camera

To develop stereoscopic perception, brain needs to have two perspectives of the object, one from the left and the other from right side. This requires two separate cameras that provide separate side by side images and a method of blanking out alternate images from a left and right camera so the viewer sees the alternate images with a left eye followed by a right eye. This can be achieved using two endoscopes each attached to a camera. Alternatively, in the known systems today dual lenses are provided in an endoscope with left and right cameras to provide left and right images for viewing. Various combinations of additional prisms, mirrors, refracting lenses have been positioned either in the entry pupil or the exit pupil to achieve the same objective. In all these cases two focusing lenses are needed instead of one as there are two separate sets of image rays or image paths that create two separate images. These two channel endoscopes may instead have a single camera head with two chips. Takahashi in U.S. Pat. No.: 5,522,789 described a stereo-endoscope with a single optical axis but a pair of imaging devices. Becker in U.S. Pat. No.: 5,944,655 described a 3D video endoscope with two lenses at the front end, a single beam path alternately used by the beams by an optical switch projecting image onto a single camera. Schoolman 1984 U.S. Pat. No.: 4,651,201 disclosed an endoscope with a beam splitter and two oculars for two camera heads. Chaleki et al 1996 U.S. Pat. No.: 5,751,341 description of a 3D endoscope system also includes possibly a two camera system from the description of the text

Such systems are plagued with three problems. First, the size of the endoscope having two optic channels is significantly larger and may be prohibitive to be introduced into a body cavity because of higher risk of injury. Second, the two cameras or a single camera head with two chips add to the weight of the endoscope making it difficult to perform delicate operations. Thirdly, it is difficult to precisely tune two cameras or the two chips in a single camera to same quality, color, hue and tint of the images. As a result slight difference in these properties of the images projected to the right and the left eye cause excessive eye strain and may be prohibitive in long operations.

Proposals have been made in the prior art for stereographic imaging using only one camera system and single optic channel. These systems achieve their objective by placing a shutter over half of the optic path between the object and the lens or between the lens and the camera chip and move the shutter from side to side. An example of such a system is disclosed by Lia in U.S. Pat. No.5,222,477 that describes an endoscope camera with an aperture plate, a shutter system or color filters as an integral part of the camera. Krueger in U.S. Pat. No. 4,568,160 used a refracting member between lenses to shift the principal axis. Greening in U.S. Pat. No. 5,828,487 describe a system wherein an opaque leaf moves from side to side.

All of these systems shift the principal ray from the center of the entry pupil to one side. Thus, different perspectives, i.e., a left perspective and a right perspective, are produced which can provide stereoscopic viewing. These systems have some draw backs. First, for optimal stereposis the right and left perspectives should be equally balanced, that is the principal ray is split exactly in half. These systems do not provide a method for adjusting the filter or a method to confirm that such adjustment has been accomplished. Second, for active shutter system in the lens system, or between the lens system and the object, it is generally required to design a special camera system for this purpose. These cannot be used on conventional endoscopes without attaching a specially designed adapter to the camera head or to the endoscope adding weight to the equipment making surgical procedures more tiring and manipulation difficult.

The concept of utilizing a passive eyewear includes lenses with colored filters was disclosed in U.S. Pat. No.: 3,712,199 to Songer. The described filter is fixed in the camera system requiring specialized lens system and therefore cannot be used with an existing camera. Another drawback is that the filter is fixed in the camera lens system and cannot be moved to center it to obtain optimal stereopsis and color balance.

Huang 2001 U.S. Pat. No.: 6,580,557 presented an invention of a single lens instantaneous 3D image taking. The aperture disc has three off axis hole generating three different image perspectives on the camera. This invention is unlikely to give good quality image in an endoscope setting.

Gim 2004 U.S. Pat. No.: 7,068,416 disclosure of a three dimensional imagery where variable focal length is used to derive information about the object. This type of process is not likely to be possible in endoscopy.

Cho et al U.S. Pat. No.: 7,751,694 2005 variable focus microarray system to generate 3D endoscopic imaging cannot be used for existing endoscopes

Costales 1999 U.S. Pat. No.: 6,275,335 show a method for obtaining 3D imaging using a single lens that involves multiple active and passive polarizing filters to separate the right and left images in a microscope. Multiplicity requires that these are build into the endoscope or its camera. This would preclude using these in an existing system such as our invention can be.

Goldstein 2002 U.S. Pat. No.: 6,396,873 B1 shows a method of using a lenticular array on the imaging chip to separate the right and the left images. However, this method reduces the resolution by half and cannot be used to modify conventional endoscope.

The present invention addresses these drawbacks. First, it offers a solution to converting a conventional endoscope into a stereoscopic device without the limitations of the prior art. Second, it describes a method for centering the optical filter and confirming that it is appropriately centered.

### BRIEF SUMMARY OF INVENTION

The present invention avoids the necessity of placing a specialized active switching device between the endoscope and the camera or requiring two separate imaging systems and needs only a single image path between an image and a camera. Whereas the existing stereoscopic endoscope systems that use a single image path all require a special lens system that has a active shutter or other mechanism in the lens system or else position a shutter prism or the like between the object and the lens system, it has now been found that a two dimensional lens scope such as an endoscope can be adapted for stereoscopic viewing without placing an active switching mechanism between the scope and the camera. This permits utilizing existing two dimensional lens systems such as endoscopes without structural modifications. In all cases, only a single image path is required.

Object of the invention is to obtain stereoscopic imaging with a conventional single optic channel endoscope using a single lens camera. The disclosed device comprises a central aperture. On the left and the right half of the aperture is a complimentary additive and subtractive color filter. The device is placed between the endoscope and the camera attachment. The left image perspective is then recorded through one filter and the right image perspective through the other filter on the same camera. Because the two perspectives see the object, there is no need to refocus or change the optics between perspectives. The object is seen from both perspectives.

The device is mounted between the endoscope and camera with or without a housing, it is important that it is exactly in the center to split the principal ray into right and left perspective to get optimal stereopsis. For this the present invention describes a method by which the filter can be adjusted so that it is appropriately centered. While the prior art does not suggest a method by which it can be confirmed that the filter is in the center, the present invention makes it easy to confirm the filter is appropriately centered. When the filter is in the center, the principal ray is split equally into the two complimentary filters and equal amounts of complimentary color elements of the image reach the camera. Image viewed with the naked eye on the video monitor is color balanced when the filter is appropriately in the center.

A specific objective of the invention is that the device or its housing is easy to mount and remove.

A specific objective of the invention is to prevent incorrect orientation of the device. Hence the device has a notch to advise the surgeon of correct orientation for the placement of the filter on the endoscope.

The images from the present invention may be displayed on a conventional video monitor for use with passive eyewear. When viewed through the same set of complimentary color filters the stereoscopic view is perceived by the viewing person. Alternatively, color balanced eye wear available in prior art such as commercially available ColorCode 3D glasses (American Paper Optics, LLC, Bartlett, Tenn.) that provide better color balance may be used. The images may be displayed on specialized video monitors with color correction for use with polarized shutter glasses or passive polarized glasses.

Other aspects, features and advantages of the invention will become apparent from the following description and from the claims

### BRIEF DESCRIPTION OF DRAWINGS

In drawings which illustrate embodiments of the present invention,

FIG. 1A shows the conventional endoscope and the camera head

FIG. 1B is a schematic diagram showing a two dimensional single image path system known in the prior art with a endoscope lens system and a camera.

FIG. 2A shows the invention, a device mounted on the endoscope between the endoscope and the camera

FIG. 2B is a schematic diagram showing the single image path system of FIG. 1B with the device according to one embodiment of the present invention placed between the endoscope and the camera to provide stereoscopic viewing,

FIG. 3A is the sectional view of the device according to one embodiment of the present invention.

FIG. 3B is the exploded view of the device according to one embodiment of the present invention

FIG. 4A is a schematic view of the adapter containing the filter and optical elements according to another embodiment of the present invention.

FIG. 4B is the frontal view of the adapter containing the filter and adjustment mechanism.

### DETAILED DESCRIPTION OF THE INVENTION

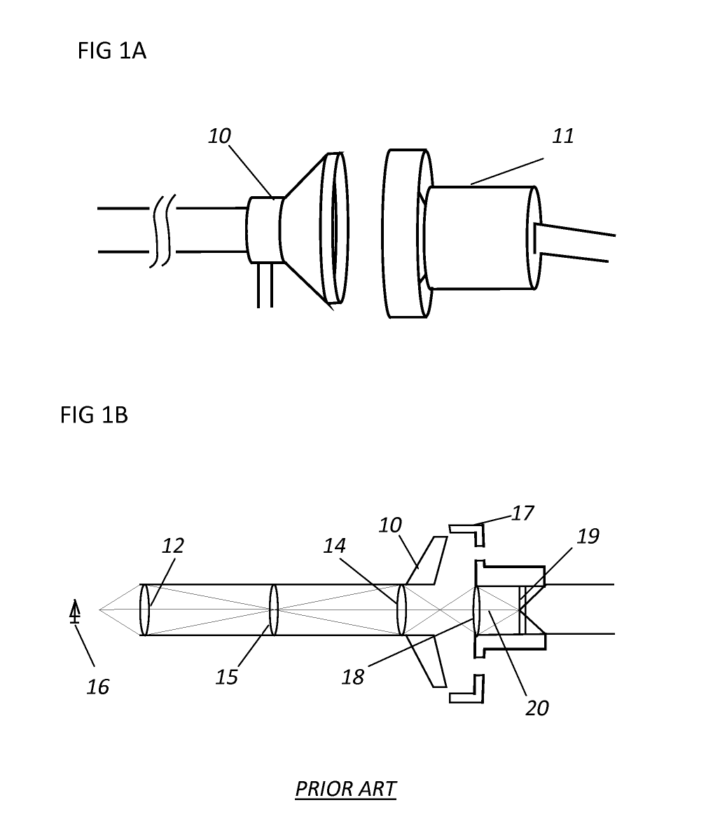

FIG. 1A illustrates a known type of endoscope 10 for two dimensional viewing using a camera 11. In schematic FIG. 1B as shown, the endoscope 10 has entry lenses 12 and exit lenses 14 with other lens 15 there between. Rays from an object 16 pass through the entry pupil and entry lens 12. A coupler 17 couples the endoscope to the camera 11. The rays are focused by a focusing lens 18 on the light sensitive element 19 of the camera 11. The principal ray 20 is shown at the central axis of the endoscope 10.

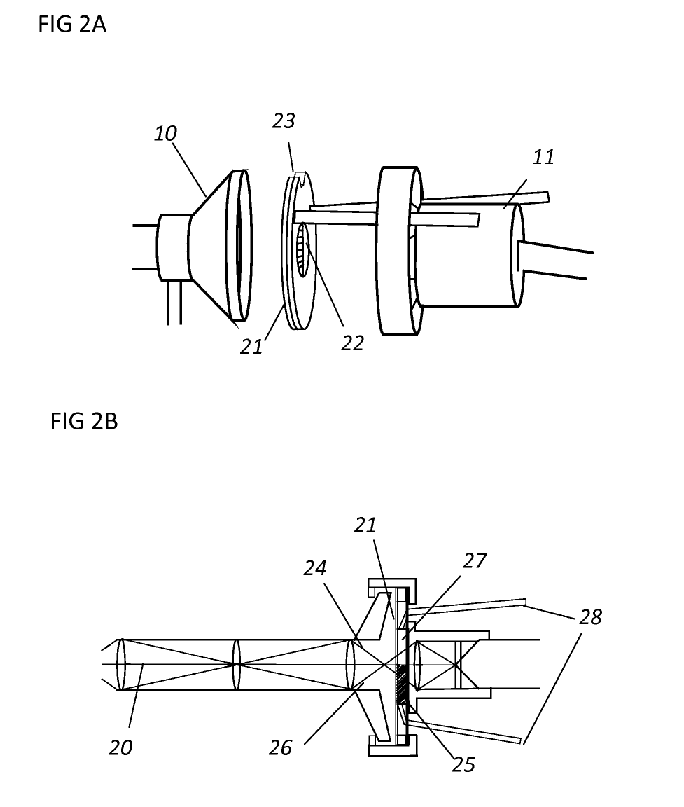

FIG. 2A shows the endoscope 10 of FIG. 1 modified for stereoscopic viewing system by placing the device 21 with an aperture 22, disclosed herewith, between the endoscope 10 and the camera 11 with notch 23 on the device positioned at the top. As in FIG. 2B, the left perspective ray 24 passes through the left filter 25 and the right perspective ray 26 passes through the right filter 27 of the device 21. Thus, the camera sees a different perspective view of the object in the single image path. Handles 28 are used to center the filter on the principal ray 20. When appropriately centered the image on the video monitor on being viewed with the naked eye is white balanced since equal amounts of light pass through each of the complimentary color filters 25 & 27 to reach the light sensitive element 19 in the camera

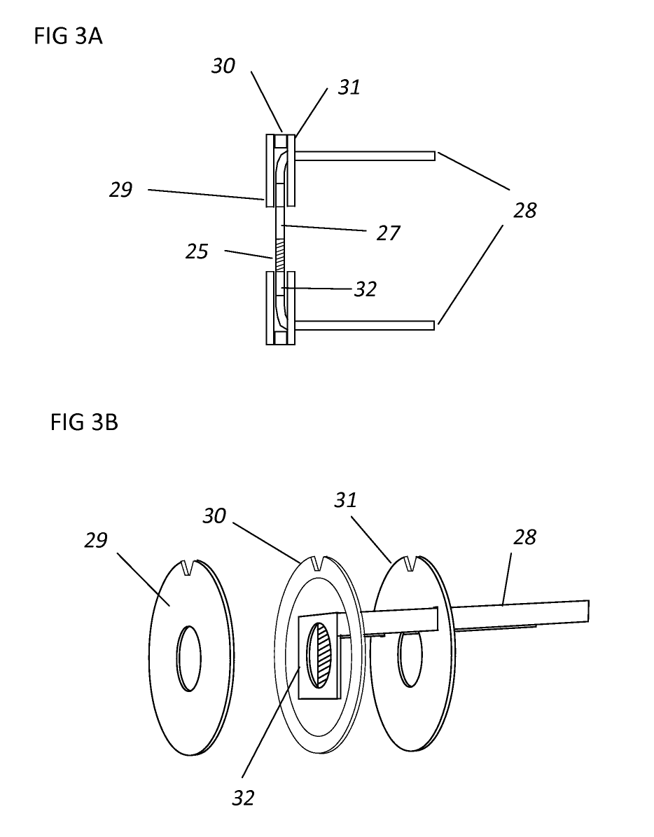

Referring now to FIG. 3, the device comprises of a front support disc 29, separator disc 30 and a back support disc 31. A filter caddy 32 containing the color filter 25 and 27 lie within the front and back support discs. The filter caddy 32 has handles 28 that can be used to center the filters on the principle ray.

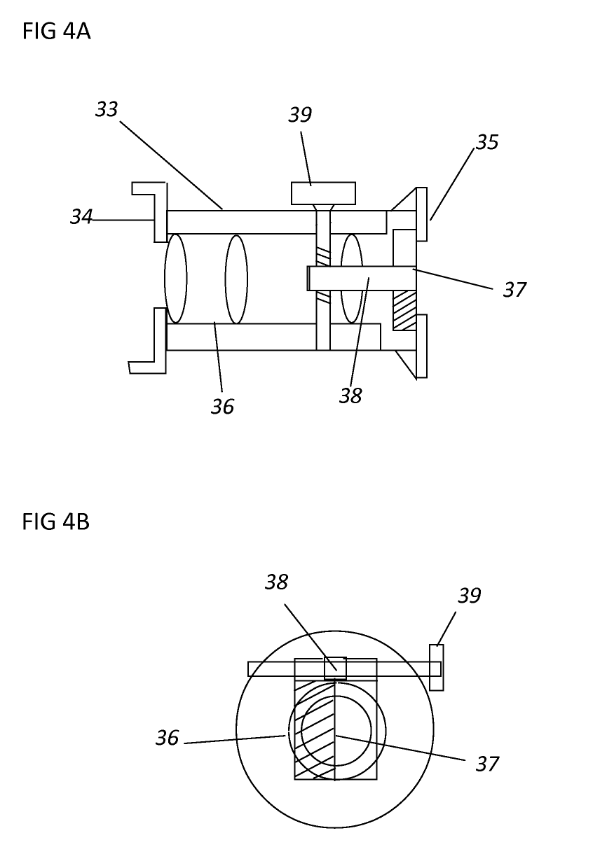

FIG. 4 shows another embodiment wherein an adapter 33 is placed between the endoscope and the camera. The adapter has a coupler 34 for attachment to the endoscope and coupler 35 for attachment to the camera. The optical tube 36 contains lens elements for focus and zoom. The filter caddy 37 is attached through an element 38 to an adjustment screw 39 so that the filter may be moved transversely to center on the principal ray.

Other changes may be made to the embodiments shown herein without departing from the scope of the present invention which is limited only by the following claims.

1. A device with a central aperture each half of which has complimentary additive and subtractive color filters.

2. The device according to claim 1 that is placed between a conventional single optic channel endoscope and single lens camera.

3. The device according to claim 1, which has a snap or others means such as adhesive to hold it in place.

4. The device according to claim 1, which has a notch or a marker that would provide a guide to appropriate orientation for placement.

5. The device according to claim 1, that has a mechanism to center the filter on the principal ray after placement.

6. The device according to claim 1 that may be housed in an adapter for attachment to the endoscope at one end and the camera at the other end.

7. The device according to claim 6 that is housed in an adapter which has lens elements for focus or zoom.

8. The device according to claim 6 that has a mechanism to center the filter on the principal ray after placement.
